(19) United States
(12) Patent Application Publication
(10) Pub. No.: US 2014/0347328 A1
(43) Pub. Date: Nov. 27, 2014

(54) CONTENT SELECTION IN A PEN-BASED COMPUTING SYSTEM

(71) Applicants: Tracy L. Edgecomb, Berkeley, CA (US); Andrew J. Van Schaack, Nashville, TN (US)

(72) Inventors: Tracy L. Edgecomb, Berkeley, CA (US); Andrew J. Van Schaack, Nashville, TN (US)

(73) Assignee: LIVESCRIBE, Oakland, CA (US)

(21) Appl. No.: 14/119,256

(22) PCT Filed: May 23, 2012
(86) PCT No.: PCT/US2012/039184

§ 371 Date: May 16, 2014

Related U.S. Application Data
(60) Provisional application No. 61/489,235, filed on May 23, 2011.

(51) Int. Cl. G06F 3/0354; G06F 3/16; G06F 3/038

(52) U.S. Cl. CPC G06F 3/03545; G06F 3/0383; G06F 3/162
USPC 345/179

(57) ABSTRACT

A method of selecting content using a pen-based computing system. Gestures generated by a user with a smart pen on a writing surface are captured and used to select content. The content can be written or audio content. Optionally additional content linked to the selected content is also selected.

### BACKGROUND

This invention relates generally to pen-based computing systems, and more particularly to selecting content in a pen-based computing system.

There exist pen-based computing systems which allow for digitally capturing written content generated with the pen-based computing system and also capturing audio content which is optionally linked to the written content. Conventionally, providing a copy of the captured written content and/or audio content, means providing all of the content captured in a particular session. However, providing all of the content may not be appropriate. For example, if many topics are discussed in a meeting and only one topic is of relevance to the recipient, providing that recipient the content of the entire meeting is just superfluous in some instances. In other instances, other topics in the meeting may not be appropriate to share with the recipient for privacy or security reasons, for example. Thus, the portion of the meeting relevant to the recipient must be laboriously recreated without the other meeting material just to provide to the recipient.

Accordingly, a new mode of communication is needed that allows for efficient selection of content.

### SUMMARY

Disclosed methods select portions of content in a pen-based computing system. The selected content can be any kind of content. In some embodiments, the content is audio or written content. The content is selected using gestures made by a smart pen on a writing surface. To select written content, gestures include encircling the written content to be selected, drawing a line in the margin next to the written content to be selected and tap opposing corners of a box enclosing the written content to be selected. To select audio content, gestures include marking time points on a line representing the timeline of the audio file.

Embodiments of the invention also include creating links between different types of content such as written content, audio content, photographs, video content, links to additional files, etc. When content is selected, linked content is optionally also selected.

Additional embodiments of the invention include rules governing how linked content is added to selected content.

Systems and computer program products implementing the disclosed methods are also described.

### BRIEF DESCRIPTION OF THE DRAWINGS

FIG. 1 is a schematic diagram of a pen-based computing system, in accordance with an embodiment of the invention.

FIG. 2 is a diagram of a smart pen for use in the pen-based computing system, in accordance with an embodiment of the invention.

FIG. 3 is a flow chart illustrating a method of selecting content in a pen based computing system.

FIG. 4 is selection of written content in a pen-based computing system according to one embodiment.

FIG. 5 is selection of written content in a pen-based computing system according to one embodiment.

FIG. 6 is selection of audio content in a pen-based computing system according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview of Pen-Based Computing System

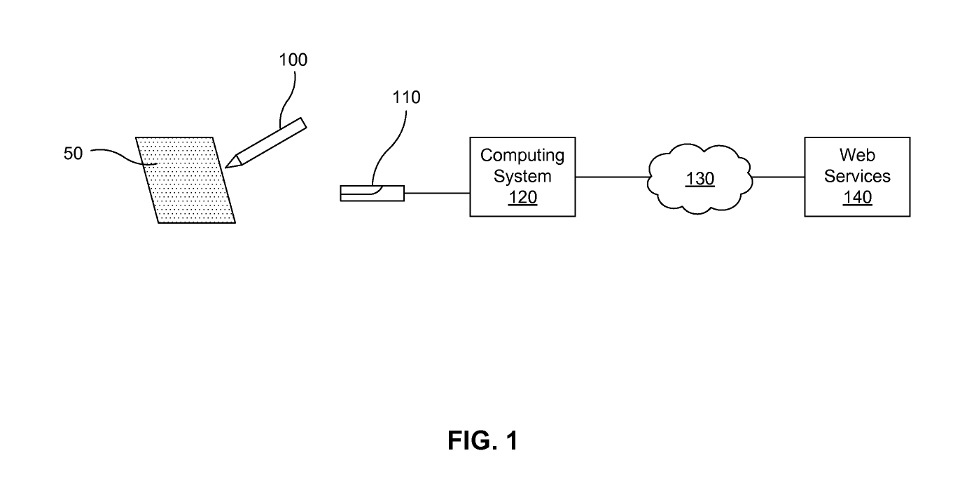

Embodiments of the invention may be implemented on various embodiments of a pen-based computing system, and other computing and/or recording systems. An embodiment of a pen-based computing system is illustrated in FIG. 1. In this embodiment, the pen-based computing system comprises a writing surface 50, a smart pen 100, a docking station 110, a client system 120, a network 130, and a web services system 140. The smart pen 100 includes onboard processing capabilities as well as input/output functionalities, allowing the pen-based computing system to expand the screen-based interactions of traditional computing systems to other surfaces on which a user can write. For example, the smart pen 100 may be used to capture electronic representations of writing as well as record audio during the writing, and the smart pen 100 may also be capable of outputting visual and audio information back to the user. With appropriate software on the smart pen 100 for various applications, the pen-based computing system thus provides a new platform for users to interact with software programs and computing services in both the electronic and paper domains.

In the pen based computing system, the smart pen 100 provides input and output capabilities for the computing system and performs some or all of the computing functionalities of the system. Hence, the smart pen 100 enables user interaction with the pen-based computing system using multiple modalities. In one embodiment, the smart pen 100 receives input from a user, using multiple modalities, such as capturing a user's writing or other hand gesture or recording audio, and provides output to a user using various modalities, such as displaying visual information or playing audio. In other embodiments, the smart pen 100 includes additional input modalities, such as motion sensing or gesture capture, and/or additional output modalities, such as vibrational feedback.

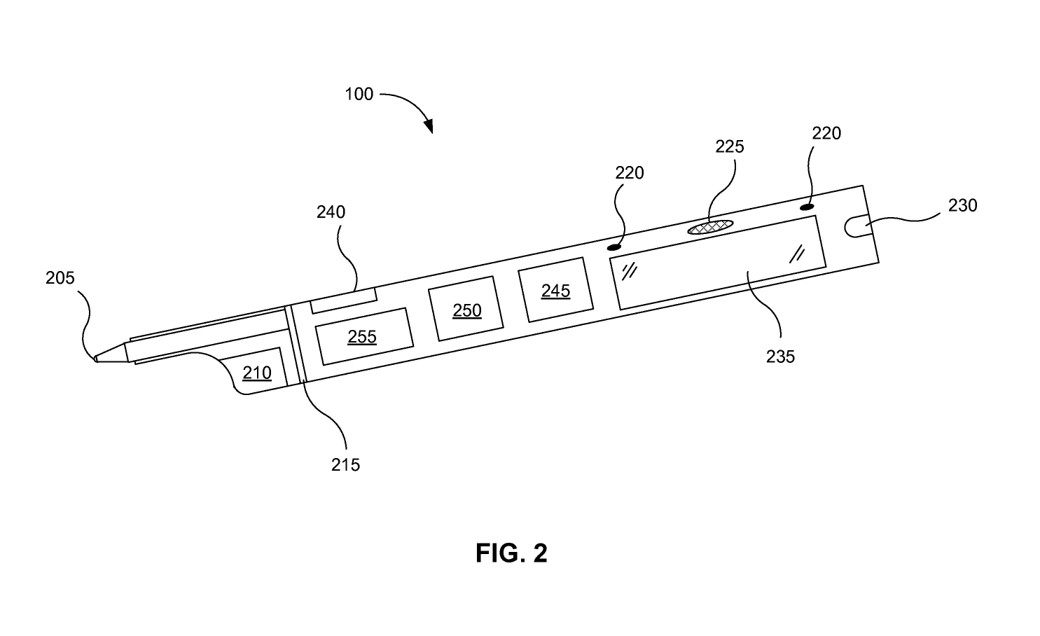

The components of a particular embodiment of the smart pen 100 are shown in FIG. 2 and described in more detail in the accompanying text. The smart pen 100 preferably has a form factor that is substantially shaped like a pen or other writing implement, although certain variations on the general shape may exist to accommodate other functions of the pen, or may even be an interactive multi-modal non-writing implement. For example, the smart pen 100 may be slightly thicker than a standard pen so that it can contain additional components, or the smart pen 100 may have additional structural features (e.g., a flat display screen) in addition to the structural features that form the pen shaped form factor. Additionally, the smart pen 100 may also include any mechanism by which a user can provide input or commands to the smart pen computing system or may include any mechanism by which a user can receive or otherwise observe information from the smart pen computing system.

The smart pen 100 is designed to work in conjunction with the writing surface 50 so that the smart pen 100 can capture writing that is made on the writing surface 50. In one embodiment, the writing surface 50 comprises a sheet of paper (or any other suitable material that can be written upon) and is encoded with a pattern that can be read by the smart pen 100. An example of such a writing surface 50 is the so-called “dot-enabled paper” available from Anoto Group AB of Sweden (local subsidiary Anoto, Inc. of Waltham, Mass.), and described in U.S. Pat. No. 7,175,095, incorporated by reference herein. This dot-enabled paper has a pattern of dots encoded on the paper. A smart pen 100 designed to work with this dot enabled paper includes an imaging system and a processor that can determine the position of the smart pen's writing tip with respect to the encoded dot pattern. This position of the smart pen 100 may be referred to using coordinates in a predefined “dot space,” and the coordinates can be either local (i.e., a location within a page of the writing surface 50) or absolute (i.e., a unique location across multiple pages of the writing surface 50).

In other embodiments, the writing surface 50 may be implemented using mechanisms other than encoded paper to allow the smart pen 100 to capture gestures and other written input. For example, the writing surface may comprise a tablet or other electronic medium that senses writing made by the smart pen 100. In another embodiment, the writing surface 50 comprises electronic paper, or e-paper. This sensing may be performed entirely by the writing surface 50 or in conjunction with the smart pen 100. Even if the role of the writing surface 50 is only passive (as in the case of encoded paper), it can be appreciated that the design of the smart pen 100 will typically depend on the type of writing surface 50 for which the pen based computing system is designed. Moreover, written content may be displayed on the writing surface 50 mechanically (e.g., depositing ink on paper using the smart pen 100), electronically (e.g., displayed on the writing surface 50), or not at all (e.g., merely saved in a memory). In another embodiment, the smart pen 100 is equipped with sensors to sensor movement of the pen's tip, thereby sensing writing gestures without requiring a writing surface 50 at all. Any of these technologies may be used in a gesture capture system incorporated in the smart pen 100.

In various embodiments, the smart pen 100 can communicate with a general purpose computing system 120, such as a personal computer, smart phone, tablet computer, etc., for various useful applications of the pen based computing system. For example, content captured by the smart pen 100 may be transferred to the computing system 120 for further use by that system 120. For example, the computing system 120 may include management software that allows a user to store, access, review, delete, and otherwise manage the information acquired by the smart pen 100. Downloading acquired data from the smart pen 100 to the computing system 120 also frees the resources of the smart pen 100 so that it can acquire more data. Conversely, content may also be transferred back onto the smart pen 100 from the computing system 120. In addition to data, the content provided by the computing system 120 to the smart pen 100 may include software applications that can be executed by the smart pen 100.

The smart pen 100 may communicate with the computing system 120 via any of a number of known communication mechanisms, including both wired and wireless communications. In one embodiment, the pen based computing system includes a docking station 110 coupled to the computing system. The docking station 110 is mechanically and electrically configured to receive the smart pen 100, and when the smart pen 100 is docked the docking station 110 may enable electronic communications between the computing system 120 and the smart pen 100. The docking station 110 may also provide electrical power to recharge a battery in the smart pen 100. In an alternative embodiment, the smart pen 100 communicates with the computing system 120 via a USB connection.

FIG. 2 illustrates an embodiment of the smart pen 100 for use in a pen based computing system, such as the embodiments described above. In the embodiment shown in FIG. 2, the smart pen 100 comprises a marker 205, an imaging system 210, a pen down sensor 215, one or more microphones 220, a speaker 225, an audio jack 230, a display 235, an I/O port 240, a processor 245, an onboard memory 250, and a battery 255. It should be understood, however, that not all of the above components are required for the smart pen 100, and this is not an exhaustive list of components for all embodiments of the smart pen 100 or of all possible variations of the above components. For example, the smart pen 100 may also include buttons, such as a power button or an audio recording button, and/or status indicator lights. Moreover, as used herein in the specification and in the claims, the term “smart pen” does not imply that the pen device has any particular feature or functionality described herein for a particular embodiment, other than those features expressly recited. A smart pen may have any combination of fewer than all of the capabilities and subsystems described herein.

The marker 205 enables the smart pen to be used as a traditional writing apparatus for writing on any suitable surface. The marker 205 may thus comprise any suitable marking mechanism, including any ink-based or graphite-based marking devices or any other devices that can be used for writing. In one embodiment, the marker 205 comprises a replaceable ballpoint pen element. The marker 205 is coupled to a pen down sensor 215, such as a pressure sensitive element. The pen down sensor 215 thus produces an output when the marker 205 is pressed against a surface, thereby indicating when the smart pen 100 is being used to write on a surface.

The imaging system 210 comprises sufficient optics and sensors for imaging an area of a surface near the marker 205. The imaging system 210 may be used to capture handwriting and gestures made with the smart pen 100. For example, the imaging system 210 may include an infrared light source that illuminates a writing surface 50 in the general vicinity of the marker 205, where the writing surface 50 includes an encoded pattern. By processing the image of the encoded pattern, the smart pen 100 can determine where the marker 205 is in relation to the writing surface 50. An imaging array of the imaging system 210 then images the surface near the marker 205 and captures a portion of a coded pattern in its field of view. Thus, the imaging system 210 allows the smart pen 100 to receive data using at least one input modality, such as receiving written input. The imaging system 210 incorporating optics and electronics for viewing a portion of the writing surface 50 is just one type of gesture capture system that can be incorporated in the smart pen 100 for electronically capturing any writing gestures made using the pen, and other embodiments of the smart pen 100 may use any other appropriate means for achieve the same function.

In an embodiment, data captured by the imaging system 210 is subsequently processed, allowing one or more content recognition algorithms, such as character recognition, to be applied to the received data. In another embodiment, the imaging system 210 can be used to scan and capture written content that already exists on the writing surface 50 (e.g., and not written using the smart pen 100). The imaging system 210 may further be used in combination with the pen down sensor 215 to determine when the marker 205 is touching the writing surface 50. As the marker 205 is moved over the surface, the pattern captured by the imaging array changes, and the user's handwriting can thus be determined and captured by a gesture capture system (e.g., the imaging system 210 in FIG. 2) in the smart pen 100. This technique may also be used to capture gestures, such as when a user taps the marker 205 on a particular location of the writing surface 50, allowing data capture using another input modality of motion sensing or gesture capture.

Another data capture device on the smart pen 100 are the one or more microphones 220, which allow the smart pen 100 to receive data using another input modality, audio capture. The microphones 220 may be used for recording audio, which may be synchronized to the handwriting capture described above. In an embodiment, the one or more microphones 220 are coupled to signal processing software executed by the processor 245, or by a signal processor (not shown), which removes noise created as the marker 205 moves across a writing surface and/or noise created as the smart pen 100 touches down to or lifts away from the writing surface. In an embodiment, the processor 245 synchronizes captured written data with captured audio data. For example, a conversation in a meeting may be recorded using the microphones 220 while a user is taking notes that are also being captured by the smart pen 100. Synchronizing recorded audio and captured handwriting allows the smart pen 100 to provide a coordinated response to a user request for previously captured data. For example, responsive to a user request, such as a written command, parameters for a command, a gesture with the smart pen 100, a spoken command or a combination of written and spoken commands, the smart pen 100 provides both audio output and visual output to the user. The smart pen 100 may also provide haptic feedback to the user.

The speaker 225, audio jack 230, and display 235 provide outputs to the user of the smart pen 100 allowing presentation of data to the user via one or more output modalities. The audio jack 230 may be coupled to earphones so that a user may listen to the audio output without disturbing those around the user, unlike with a speaker 225. Earphones may also allow a user to hear the audio output in stereo or full three-dimensional audio that is enhanced with spatial characteristics. Hence, the speaker 225 and audio jack 230 allow a user to receive data from the smart pen using a first type of output modality by listening to audio played by the speaker 225 or the audio jack 230.

The display 235 may comprise any suitable display system for providing visual feedback, such as an organic light emitting diode (OLED) display, allowing the smart pen 100 to provide output using a second output modality by visually displaying information. In use, the smart pen 100 may use any of these output components to communicate audio or visual feedback, allowing data to be provided using multiple output modalities. For example, the speaker 225 and audio jack 230 may communicate audio feedback (e.g., prompts, commands, and system status) according to an application running on the smart pen 100, and the display 235 may display word phrases, static or dynamic images, or prompts as directed by such an application. In addition, the speaker 225 and audio jack 230 may also be used to play back audio data that has been recorded using the microphones 220.

The input/output (I/O) port 240 allows communication between the smart pen 100 and a computing system 120, as described above. In one embodiment, the I/O port 240 comprises electrical contacts that correspond to electrical contacts on the docking station 110, thus making an electrical connection for data transfer when the smart pen 100 is placed in the docking station 110. In another embodiment, the I/O port 240 simply comprises a jack for receiving a data cable (e.g., Mini-USB or Micro-USB). Alternatively, the I/O port 240 may be replaced by a wireless communication circuit in the smart pen 100 to allow wireless communication with the computing system 120 (e.g., via Bluetooth, WiFi, infrared, or ultrasonic).

A processor 245, onboard memory 250, and battery 255 (or any other suitable power source) enable computing functionalities to be performed at least in part on the smart pen 100. The processor 245 is coupled to the input and output devices and other components described above, thereby enabling applications running on the smart pen 100 to use those components. In one embodiment, the processor 245 comprises an ARM9 processor, and the onboard memory 250 comprises a small amount of random access memory (RAM) and a larger amount of flash or other persistent memory. As a result, executable applications can be stored and executed on the smart pen 100, and recorded audio and handwriting can be stored on the smart pen 100, either indefinitely or until offloaded from the smart pen 100 to a computing system 120. For example, the smart pen 100 may locally stores one or more content recognition algorithms, such as character recognition or voice recognition, allowing the smart pen 100 to locally identify input from one or more input modality received by the smart pen 100.

In an embodiment, the smart pen 100 also includes an operating system or other software supporting one or more input modalities, such as handwriting capture, audio capture or gesture capture, or output modalities, such as audio playback or display of visual data. The operating system or other software may support a combination of input modalities and output modalities and manages the combination, sequencing and transitioning between input modalities (e.g., capturing written and/or spoken data as input) and output modalities (e.g., presenting audio or visual data as output to a user). For example, this transitioning between input modality and output modality allows a user to simultaneously write on paper or another surface while listening to audio played by the smart pen 100, or the smart pen 100 may capture audio spoken from the user while the user is also writing with the smart pen 100. Various other combinations of input modalities and output modalities are also possible.

In an embodiment, the processor 245 and onboard memory 250 include one or more executable applications supporting and enabling a menu structure and navigation through a file system or application menu, allowing launch of an application or of a functionality of an application. For example, navigation between menu items comprises a dialogue between the user and the smart pen 100 involving spoken and/or written commands and/or gestures by the user and audio and/or visual feedback from the smart pen computing system. Hence, the smart pen 100 may receive input to navigate the menu structure from a variety of modalities.

For example, a writing gesture, a spoken keyword, or a physical motion, may indicate that subsequent input is associated with one or more application commands. For example, a user may depress the smart pen 100 against a surface twice in rapid succession then write a word or phrase, such as “solve,” “send,” “translate,” “email,” “voice-email” or another predefined word or phrase to invoke a command associated with the written word or phrase or receive additional parameters associated with the command associated with the predefined word or phrase. This input may have spatial (e.g., dots side by side) and/or temporal components (e.g., one dot after the other). Because these “quick-launch” commands can be provided in different formats, navigation of a menu or launching of an application is simplified. The “quick-launch” command or commands are preferably easily distinguishable during conventional writing and/or speech.

Alternatively, the smart pen 100 also includes a physical controller, such as a small joystick, a slide control, a rocker panel, a capacitive (or other non-mechanical) surface or other input mechanism which receives input for navigating a menu of applications or application commands executed by the smart pen 100.

### Overview of Selecting Content

The smart pen based computing system is useful for capturing audio and written content in, for example, a meeting. Sharing all or portions of audio and/or written content is desirable but a user wants flexibility to share only some of the content depending on the circumstance. There are many uses for a functionality allow users to select just a portion of content. Meetings can include many topics and a user may want to divide the record of a meeting by topic. A user may wish to send a portion of a set of notes to a contact but not the entire set of notes.

### Selecting Written Content

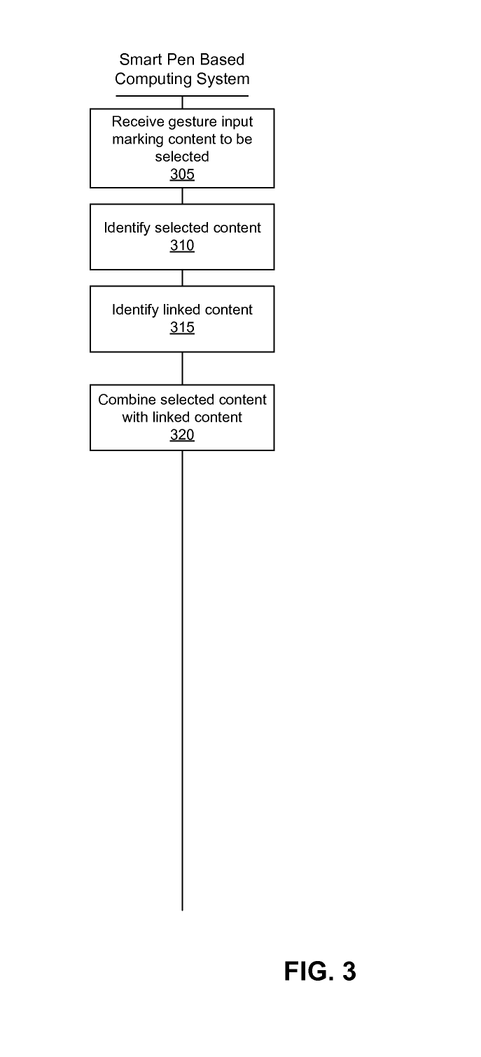

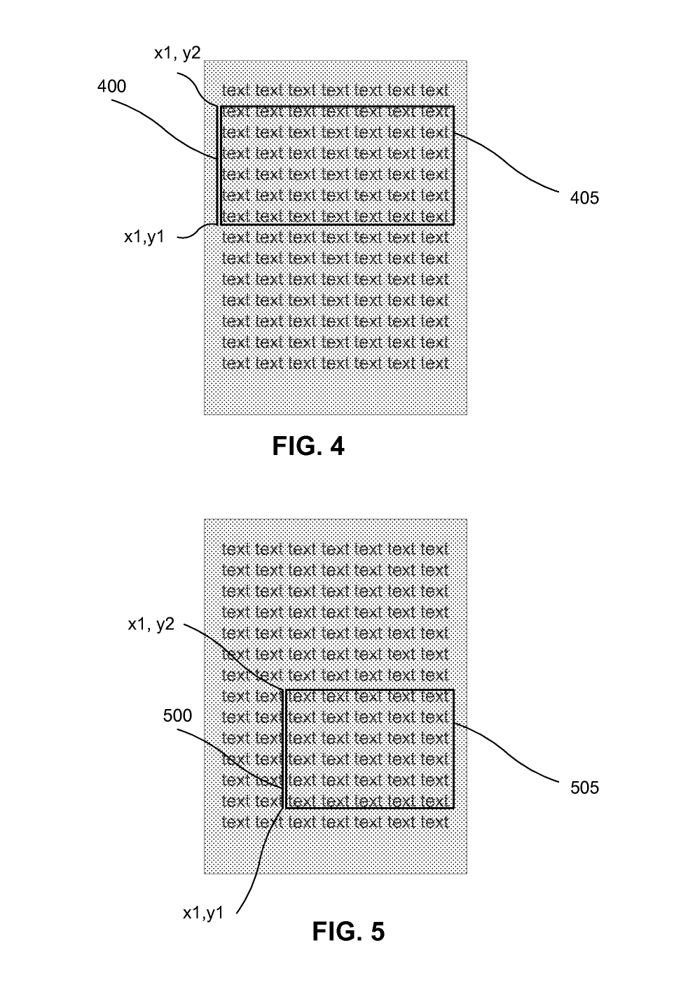

Referring to FIG. 3, the method of selecting content is described. A user selects the content selection mode on the smart pen 100 to start selecting content. Content selection mode is entered through the menu structure on the smart pen 100 or by invoking the mode by selecting an icon on the dot-enabled paper. After selecting content selection mode, the user indicates the written content that is selected. To indicate the content to be selected, the user makes gestures with the smart pen 100 on the dot-enabled paper, which are received 305 by the imaging system 210 on the smart pen 100 and interpreted to identify 310 the selected content. In some embodiments, the received gestures include one or more sets of coordinates which are used to identify 310 the selected content. For example if the gesture is a tap, the gesture received gesture includes the coordinates of the spot on which the smart pen 100 was tapped. If the gesture is the drawing of a line, the received gesture may include the coordinates of the beginning and of the line. If the gesture is the drawing of a shape, the gesture may include the coordinates of the vertices of the shape. Identifying 310 the selected content is accomplished by comparing coordinates associated with the content with the coordinates of the gesture and applying rules that indicate whether to include or exclude text based on its position relative to the gesture's coordinates. Various ways to select content include:
Select a single page—Tap a single tap on the desired page. All written content on the page is selected.
Select multiple pages—Tap a single tap on multiple pages (not necessarily sequential pages). Double-tap on the last page to be selected.
Select a range of pages—Draw left to right line on the first page of the range and draw a right to left line on the last page of the range. All written content on the range of pages is selected.
Selecting a portion of a page:
   Selecting a vertical portion of a page—Draw a vertical line along the right or left margin of the written content that is to be selected. All written content, or ink, that is aligned to the left or right of the drawn vertical line is selected. FIG. 4 illustrates a line 400 and the text that is selected as a result of line 400 is encircled by box 405. The line 400 has an endpoint having coordinates x1,y1 and second endpoint x1, y2. The selected text has any x coordinate but y coordinates between y1 and y2.
   Selecting a portion of a vertical portion of a page—Draw a vertical line to the left or the right of the written content that is to be selected in such a way that the written content to be selected ends up in the larger portion of the page after the page is divided along the drawn line. FIG. 5 illustrates a line 500 drawn to the left of text that is to be selected. The text to the right of the line 500 (encircled by box 505) is in the larger portion of the page as divided by line 500 and thus it is the selected text. The line 500 has an endpoint having coordinates x1,y1 and second endpoint x1,y2. The selected text has an x coordinate greater than x1 and a y coordinate between y1 and y2.
   Selecting a rectangular portion of a page—Tap on two opposing corners of the rectangular portion of the page that contains the written content to be selected.
   Selecting a contiguous portion of a page of any shape—Draw a line around the written content to be selected ending the line at its beginning This is analogous to lasso tools in drawing programs.

To select multiple pieces of written content that are not contiguous, the methods of selecting content can be combined. For example, a user can select a rectangle of written content on one page together with the entirety of another page and a range of pages elsewhere.

Optionally, the combination of gestures can be used to subtract content from the selection. In such an embodiment, a user could select a whole page except a certain portion by tapping the page to select that page and then encircling a portion that is to be excluded. That the second selected portion is to be removed from the first selected portion (the page) is indicated by a gesture indicting exclusion between the two selections.

Selecting Audio Content

In order to select audio content, the user enters the selection mode of the smart pen 100 using the menu structure on the smart pen 100 or by selecting an icon on the dot-enabled paper. The user then selects portions of audio content using the menu structure, icons on the dot-enabled paper or a combination of the two.

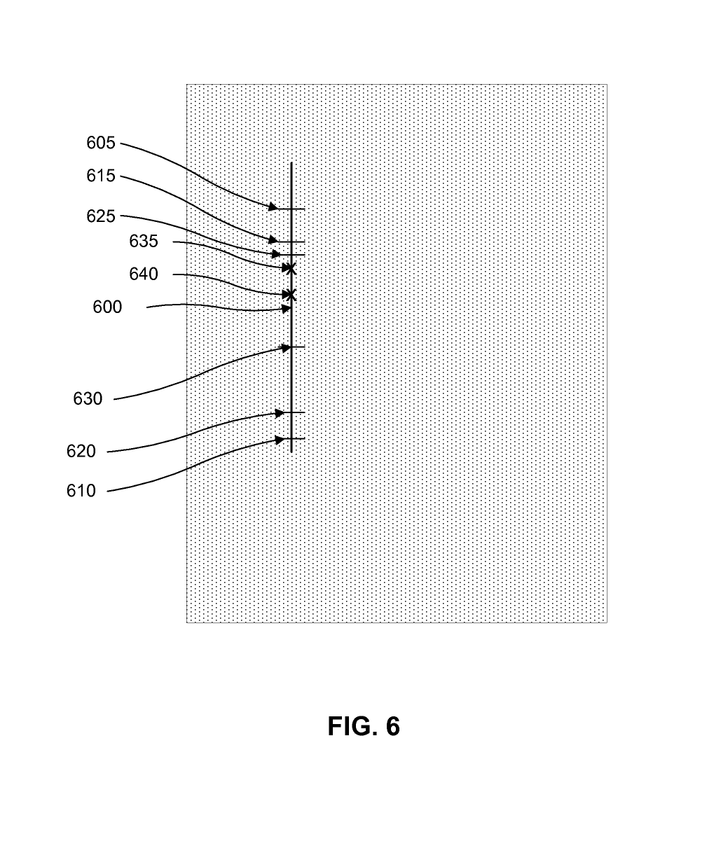

When audio content has been recorded together with the writing of written content, selecting written content allows automatic selection of the audio content that is associated with the written content.
Selecting an entire audio file—Entire audio files are selected from a list of available audio recordings. The list is accessed, for example, via the menu structure on the smart pen 100.
Selecting audio associated with written content—Using the gestures described previously for selection of written content, the audio content that is synchronized to written content can be selected by selecting the written content corresponding to the desired audio content. The audio content alone can be selected this way or audio and written content can be selected this way. Selection options for linked content are discussed in greater detail below.
Selecting the beginning or end of an audio file—The user navigates through an audio file to select a position at which the selected audio content is to start or end. The user navigates through the audio file using gestures on dot-enabled paper or selecting icons on dot-enabled paper corresponding to fast forward, reverse, jump forward, jump backward, jump to, etc. and makes a gesture on the dot enabled paper with the smart pen 100 that indicates whether the selected position is to be the starting point or ending point of the selected audio content. If the selected position is to be the end of selected content, the selected audio content will be the beginning of the audio file to the selected position. If the selected position is to be the beginning of the selected content, the selected audio content will start at the selected position and end at the end of the audio file.
Selecting a portion from the middle of an audio file—Referring to FIG. 6, the user draws a vertical line 600 to represent an audio timeline. The vertical line 600 has coordinates identifying its beginning and end. To start the editing process, the user locates the position in the audio file at which they would like their selection to begin, and makes a mark 605 near the top of the vertical line. User then locates the position in the audio file at which they would like their selection to end, and makes a mark 610 near the bottom of the vertical line. The user can then adjust the starting and ending points of the selected audio content by making the selected portion shorter at either the beginning or the end or both by moving through the audio file and making additional marks on the vertical line 600 to mark the new beginning and new end of the selected audio content. Marks 615 and 625 are made as the beginning of the selected portion is fine tuned and made later and later into the audio file. Marks 620 and 630 are made as the end of the selected portion is fine tuned and made earlier and earlier into the audio file. The distance between the marks need not be to scale. The distance between marks 610 and 620 on FIG. 6 is shorter than the distance between marks 620 and 630. However the time in the audio file between positions represented by marks 610 and 620 is not necessarily shorter than the time between positions represented by marks 620 and 630. This is possible because the time point playing in the audio file at which the user makes a new mark (as identified with one or more sets of coordinates of the mark) becomes associated with that time point rather than the user having to guess where he or she is in the audio file (for example one third of the way through) and attempt to place the mark at the visual representation of that position in the audio file on the timeline. Once the selection process is completed, the center two marks 625 and 630 are used to determine the audio selection, such that the higher 625 of the two center marks represents the start time for the selected audio content and the lower 630 of the two center marks represents the end time. The smart pen 100 uses the point in time for the audio file when mark 625 was made to identify the start time for the selected audio content and the point in time of the audio file when mark 630 was made to identify the end of the selected audio content. The same method as described above can be used to remove portions of the audio from the selection. For example, X 635 marks the beginning of a portion to be excluded from the selected audio content. X 640 marks the end of the excluded portion. The result of the editing illustrated in FIG. 6 is audio content selected between marks 625 and 630 but with the portion between X 635 and X 640 removed.
Combining audio portions. Similar to combining written content selections, portions from multiple audio files can be selected together, resulting in a merged audio file, using combinations of the above methods. For example, five recordings are made in sequence, where interviewees are asked to write their name on a page and speak aloud their phone number and address. All five sessions are selected and merged, creating a single audio file that contains all the recorded audio.

### Selecting Other Content on the Smart Pen

Any other data on the smart pen 100 can be selected alone or in combination with written content and audio content. In one embodiment, the smart pen 100 can have various applications added to it, each of which can have associated data and content available for selection. Examples include:
Game data: The user could tap on a portion of a page on which controls for a game have been drawn to automatically select and link information on that game, for example the high score associated with the game.
Calculated results: To select the result of a calculation, the user could tap on the art for a calculator (either a user-drawn calculator or a Fixed Print application, such as that in the front cover of a notebook of dot-enabled paper) or on a calculation written with an app such as Quick Calc (e.g. “5.7×463”).
Composed music: The user could tap out a tune on a drawn plano or other musical or audio application and then tap the drawn instrument to select a data file that includes the music data (e.g. a MIDI file).

In one embodiment, metadata associated with the original content is included with the selected content. Example metadata includes the name or other identifying information of the user who created the content. The user information may be obtained, for example, from a unique identifier from the smart pen used to create the content. The pen used to write the note may also save the time and date that the content was created. The selected content can then include a date and time stamp for the creation of the original content as well as the date and time stamp for the creation of the selected content.

### Selecting Linked Content

Multiple content types can be linked and the linked content can be included with the selected content. Whether to include linked content can be determined manually by the user each time content is selected or automatically using rules stored on the onboard memory 250 of the smart pen 100.

A common use case for a smart pen-based computer system is for an audio recording to be made of a meeting along with written notes. Each period of time when audio is recorded results in a separate audio file. The written content made at the same time as an audio file is linked as a session. A user can also manually designate a session by combining multiple sessions into a single session. For example of a meeting is stopped and started, there may be multiple audio files and associated written content (and thus multiple sessions) that belong together. These can be grouped to create one session.

If a user selects written content from a session, it may or may not be useful to automatically add the audio portion of the session corresponding to the selected written content. Whether it is useful depends on the end use of the selected content. When sending a colleague an action item from a meeting, it may not be necessary or even useful to include what was said in the meeting at the exact moment when the note was taken. If the selected written content is for archival purposes, it is more likely to be useful to include the linked audio content. If linked content is to be included, the smart pen based computing system identifies 315 linked content and combines 320 that linked content with the selected content

Additional personalization of how much audio content to include with selected written content is possible by invoking rules. Selected written content, whether a whole page, multiple pages, a portion of a page or some combination of selections, can be associated with one or more audio files as well as portions of audio files. If a user records an hour-long meeting that results in ten pages of written content and then selects one of the ten pages of written content, that page is associated with a portion of the hour-long audio file but not one whole audio file. In another example, if a user creates a page of written content in a series of meetings and makes some recordings during those meetings but not one continuous recording, that page of written content is associated with multiple audio files. If one session including an audio file spans a portion of one page of written content onto a second page of written content, the first page of written content is associated with a portion of an audio file.

Personalization of how much audio content to include with written content is useful to avoid sending too much or too little audio content. Users can program such personalization into the smart pen 100 and have a default rule or select a rule at the beginning of selecting content. Example rules include:
Include all directly associated audio—All audio associated with the time period(s) during which the selected written content was created is included. Referring to the example of the hour-long meeting, if the user selects only one page of the ten pages of notes, only the audio associated with that one page is added to the selected content.
Include all audio files in their entirety—All audio files associated with any portion of the selected written content are included. Referring to the example of the hour-long meeting, if the user selects only one page of the ten pages of written content, all audio that is part of the session that includes that one page of notes is included. The selected content thus includes all audio content for the entire session and a portion of the written content from the session.
Include all complete audio files—All audio files that are associated in their entirety with selected written content are included. Referring to the example of the hour-long meeting, if the user selects only one page of the ten pages of written content, no audio is included under this rule as no audio file is completely encompassed within that one page of notes because the linked audio file spans all ten pages of written content. In another example, if a single page of written content includes multiple audio files and also portions of audio files (because the session to which the audio file belongs includes written content spanning multiple pages), only the audio files whose associated written content is completely contained in the selected written content is included in the selected content.
Session-based linking
   Upon selecting written content, all written content in the same session and all audio content in the session is selected.
   Upon selecting written content, all pages including written content in the same sessions and all audio content in the session is selected.
   Upon selecting a page, all written content and all audio content that is part of any session included on the selected page is selected.

### Other Features

The above embodiments of the invention may support additional features, which may be implemented together or separately to provide enhanced functionality. Some of these additional features may include the following.
Combining content from sources other than the smart pen 100. Time stamps on the smart pen 100-based content and non-smart pen 100-based content can be used to link the two. Alternatively, a user manually links the non-smart pen 100-based content to the smart-pen 100-based content.
Use examples include:
   During a brainstorming meeting, notes are written on a whiteboard. At the end of the meeting, a photo is taken of the whiteboard with a digital camera, and the photo is added to the session materials of audio content and written content. The photos can be added manually by the user or added automatically based on the date and time stamp of the photograph. Photos can also be added by photo matching. To link a series of photos with a set of notes, the user takes a picture of the page with writing, followed by other photos. Automated analysis of the photos matches the first photo in the series with the specific page of notes, and creates linkages between that and the following set of photos and the session that contains that page of notes.
   A digital slideshow is presented at a meeting. The timing of each slide is tracked, and the slideshow document is combined into the session with the audio content and written content. That way, people viewing the notes from the meeting at a later date can know which slide was being shown at any moment, and can therefore track what conversation was taking place in response to each slide.
   A lecture series is video recorded, and the time codes of the video are incorporated with the session. Later, a user can tap anywhere on the notes and not just jump to that portion of the audio content, but find the corresponding position in the video as well. In another embodiment, audio synching is used to match up the video content with the audio content.
   A meeting is held with attendees in various locations and coordinated via an online system such as WebEx. The content shared and viewed during the meeting (screenshares, spreadsheets, slideshows, etc.) and metadata (list of attendees, time of meeting start/stop) are added to the written content and audio content of the session from the smart pen 100.
Other methods of linking content include:
   Explicit User Action (real-time): A user could launch a special app on another computing device such as a smart phone, tablet computer, desktop computer, laptop computer, etc., that is meant for capturing data to be included with pen-based sessions. Any data they capture (e.g. photos, videos, audio recordings, or web locations) from within this app is automatically marked for inclusion with the simultaneous actions of the pen.
   Explicit User Action (before/after): A user could launch a special app (as above), or use a plug-in (e.g. in a computer's internet browser) to specify content to be linked with pen-based content. This could be done in advance of the creation of a session (e.g. while planning for a presentation) or afterwards (e.g. as an “annotation” to supply additional information in support of a discussion that occurred).
   Hyperlinks—Within a set of notes, the user writes a URL, website name, or search term, and marks it with a special tag. This generates a search on that web location, and the resulting website or web data is linked to the note taking session and included in future selections that include that session.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which include any type of tangible media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer-implemented method for selecting content:
digitally capturing gestures made on a writing surface using a digital pen device;
determining a selected region of the writing surface based on the captured gestures;
identifying written content associated with the selected region of the writing surface; and
storing an indication of the selection of the identified written content.

2-4. (canceled)

5. The method of claim 4, wherein capturing gestures further comprises determining a second set of coordinates.

6. The method of claim 5, wherein identifying content based on the captured gestures comprises identifying an area delineated by the one set and second set of coordinates and identifying written content located in the area.

7. The method of claim 1 wherein:
the writing surface comprises one or more pages of paper;
the gestures comprise a tap on at least one of the one or more pages; and
the selected region is the at least one of the one or more pages.

8. (canceled)

9. The method of claim 8, wherein identifying written content comprises identifying written content located on the writing surface between a first y coordinate of the first set of coordinates and a second y coordinate of the second set of coordinates.

10. The method of claim 9, wherein a first x coordinate of the first set of coordinates and a second x coordinate of the second set of coordinates is the same and identifying written content further comprises identifying written content located on a portion of the writing surface having an x coordinate greater than the first and second x coordinates.

11. The method of claim 9, wherein a first x coordinate of the first set of coordinates and a second x coordinate of the second set of coordinates is the same and identifying written content further comprises identifying written content located on a portion of the writing surface having an x coordinate less than the first and second x coordinates.

12. The method of claim 1 further comprising identifying additional content linked to the written content.

13. The method of claim 12 wherein identifying additional content comprises identifying a time stamp for the written content and identifying additional content having the time stamp.

14. The method of claim 12 wherein the additional content comprises audio content.

15. The method of claim 12 further comprising identifying additional content linked to the written content based on user-defined rules.

16.-36. (canceled)

37. A digital pen device for selecting content:
a processor;
an imaging system coupled to the processor for capturing gestures made by the digital pen device on a writing surface;
an onboard memory coupled to the processor and configured to store the gestures captured by the imaging system;
computer program code stored on a memory and configured to be executed by the processor, the computer program code including instructions for:
determining a selected region of the writing surface based on the captured gestures;
identifying written content associated with the selected region of the writing surface; and
storing an indication of the selection of the identified written content.

38-41. (canceled)

42. The digital pen device of claim 37 wherein:
the writing surface comprises one or more pages of paper;
the gestures comprise a tap on at least one of the one or more pages; and
the selected region is the at least one of the one or more pages.

43. (canceled)

44. The digital pen device of claim 43, wherein the instructions for identifying written content comprise instructions for identifying written content located on the writing surface between a first y coordinate of the first set of coordinates and a second y coordinate of the second set of coordinates.

45. The digital pen device of claim 44, wherein a first x coordinate of the first set of coordinates and a second x coordinate of the second set of coordinates is the same and wherein the instructions for identifying written content further comprise instructions for identifying written content located on a portion of the writing surface having an x coordinate greater than the first and second x coordinates.

46. The digital pen device of claim 44, wherein a first x coordinate of the first set of coordinates and a second x coordinate of the second set of coordinates is the same and wherein the instructions for identifying written content further comprise instructions for identifying written content located on a portion of the writing surface having an x coordinate less than the first and second x coordinates.

47. The digital pen device of claim 37 further comprising instructions for identifying additional content linked to the written content.

48. The digital pen device of claim 47 wherein the instructions for identifying additional content comprise instructions for identifying a time stamp for the written content and instructions for identifying additional content having the time stamp.

49. The digital pen device of claim 47 wherein the additional content comprises audio content.

50. The digital pen device of claim 47 further comprising instructions for identifying additional content linked to the written content based on user-defined rules.

51.-69. (canceled)
